(19) United States
(12) Patent Application Publication
(10) Pub. No.: US 2008/0097865 A1
(43) Pub. Date: Apr. 24, 2008

(54) Method to manage an automatic and interactive e-commerce site

(76) Inventor: Paolo Forlani, Milano (IT)

Correspondence Address: PAOLO FORLANI, VIALE CIRENE 7, MILANO, 20135, omitted

(21) Appl. No.: 11/583,498

(22) Filed: Oct. 20, 2006

(51) Int. Cl. G06Q 30/00

(52) U.S. Cl. 705/26

(57) ABSTRACT

Method to operate an Internet e-commerce site for the sale of complex systems. Price and delivery time are automatically calculated as soon as the buyer makes every single choice between options that are automatically enabled by the system based on previous choices. A printable quote is automatically generated and can be used to refine the configuration in successive interactions by sales people and buyer.

### BACKGROUND OF THE INVENTION

Several years after the appearance of the Internet, “electronic commerce” or “e-commerce” sites have been developed and used. They allow the web buyer, connected to an Internet site, to choose the goods he/she wants to buy from an electronic catalogue where also prices are shown, creating a list of goods often named “electronic basket” or “electronic shopping cart”. The web site server is equipped with a software motor that, upon buyer request, computes the total price, often also adding fixed or variable costs such as taxes and shipping charges. The buyer can add or delete goods to/from this list and the total price is automatically recalculated after confirmation by the user. Delivery dates of all items in the order are also normally shown and, depending on these, the delivery date of the total order is also computed based on the delivery date of the latest single item.

Important disadvantages of this widely diffused and well known organization are:
It is not well suited for the sale of complex goods, where the choice of an item can influence the possible choices of other items in the order: for instance, when buying a computer, the type/model of the main board allows to use only a restricted number of microprocessors and, if the user chooses a different board, the system must not accept the order with an incompatible microprocessor.
It does not consider that the delivery date of a complex system can depend on the combination of buyer choices: for instance, the time needed to assemble and test a computer can strongly depend on its configuration.
It does not consider that the price of a complex system can depend on the combination of buyer choices and in many cases cannot be computed as a simple sum of item prices.
The buyer has no immediate feeling of the effect of each single item choice on the final price and delivery date of the complex system, he can only recalculate the price at the end of a series of choices and going to a final price computation web page where the delivery date is also shown.
The Internet buyer has no advice by the site, as the one he could have by the human salesman in a physical shop, so he/she can be confused by the enormous number of different combinations of items that make up the complex system to buy; the result is that incompatible items can be chosen resulting in an impossible or not optimized complete system.
The buyer can ask an advice to the personnel of the sales organization, but only with an e-mail message and not in an interactive way as in a real shop.
There is no provision for an official quotation by the sales organization with a numbered detailed message addressed to the buyer; the buyer can only print the “shopping cart” page as a reference.
While refining the final configuration of the order, maybe in several successive steps, the sales personnel do not have a knowledge of the previous choices of the buyer and of all the configurations he/she tried before arriving to the actual configuration for which he/she asks an advice, with the result that the buyer thinks he/she is not supported by a competent sales organization and eventually prefers an old-fashioned real shop.

Usage and growth of e-commerce is not as big as it could be, and one of the causes of this problem is that buyers do not feel comfortable and feel to have a “mechanical” service, with less quality than the service by human sales people in a “physical” shop. This is a serious economic problem in technologically advanced countries such as the United States.

### SUMMARY OF THE INVENTION

The invention described here relates to the method to solve the above indicated problems.

The e-commerce motor of the web site has been designed to incorporate advanced database and artificial intelligence technologies the give the following features:
As soon as a complex product model is selected, its base price is immediately shown.
As soon as a complex product model is selected, its estimated delivery date is immediately shown.
As soon as a complex product model is selected, all the possible options (i.e., for a computer, processor model and speed, RAM memory size, type and speed, monitor . . . ) are shown.
As soon as a complex product model is selected, only the options that are compatible with the chosen model are shown.
As soon as a complex product model is selected, all the accessories that are compatible with the chosen model are shown.
As soon as an option or an accessory is changed, added or deleted, the price of the product is evaluated again and shown in the “Real Time price” box, with no need of an action by the user.
Even if the user scrolls up or down the Internet page, thus hiding part of the page itself, a “Tell me more” box is always easily reachable; this box allows the user to ask assistance by a consultant.
The computed price is always visible in a small overlapped window.
The main features of the selected model are always shown at the bottom of the page.
In case of particular conditions that allow for discounts or different charges, the new price computation is automatically evaluated and is quickly available in the “Evaluate”, “Place order”, or in the “Printable quote” pages.
The automatically computed price is directly used for the commercial transaction with no necessity for a human supervision.
A “Printable quote” can be easily and automatically generated and printed. This numbered document allows both the customer and the sales personnel to modify the configuration in an interactive way to perfect it.

From the features listed above, it can be easily understood that such organization for an e-commerce site solves all the above mentioned problems, giving advantages as:
Even for customers with little knowledge of computers, it is not possible to make wrong or incompatible choices for the configuration of complex machines.
Prices and delivery times are always clear and visible.
Buyer and salesmen can cooperate to perfect the final configuration in successive steps using the “printable quote” and its history as a reference.
The buyer feels comfortable in all the steps of his/her buying experience, even in the cases when he needs help.
The possibility of wrong on not optimized orders is eliminated, drastically reducing the cases where the sales personnel has to contact the buyer again to adjust the configuration and drastically reducing unforeseeable costs and delays.

An e-commerce site based on this invention gives the buyer the confidence he/she needs, so sales will increase with much less effort by sales people, finally resulting in an overall increase in the usage of e-commerce sites with big advantages for national economy.

### BRIEF DESCRIPTION OF THE DRAWINGS

FIG. 1 shows an example of an e-commerce web page based on the invention.

FIG. 2 shows an example of a printable quote page based on the invention.

### DETAILED DESCRIPTION OF THE PREFERRED EMBODIMENT

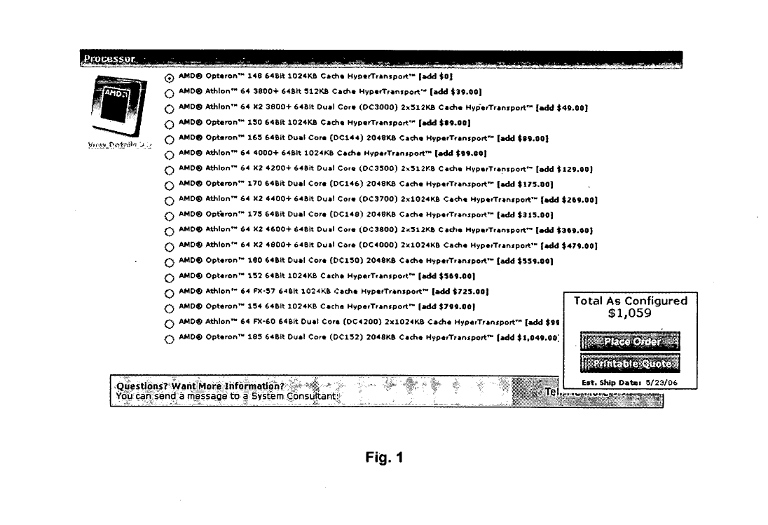

As shown in FIG. 1, the Web pages where the buyer chooses the options shows, in any phase of the choice process, the final price, the button to see the printable quote and the delivery date. If the buyer, at some point, needs some more information, he/she can ask the advice of the sales personnel, who will exactly know the choices of the buyer up to that point.

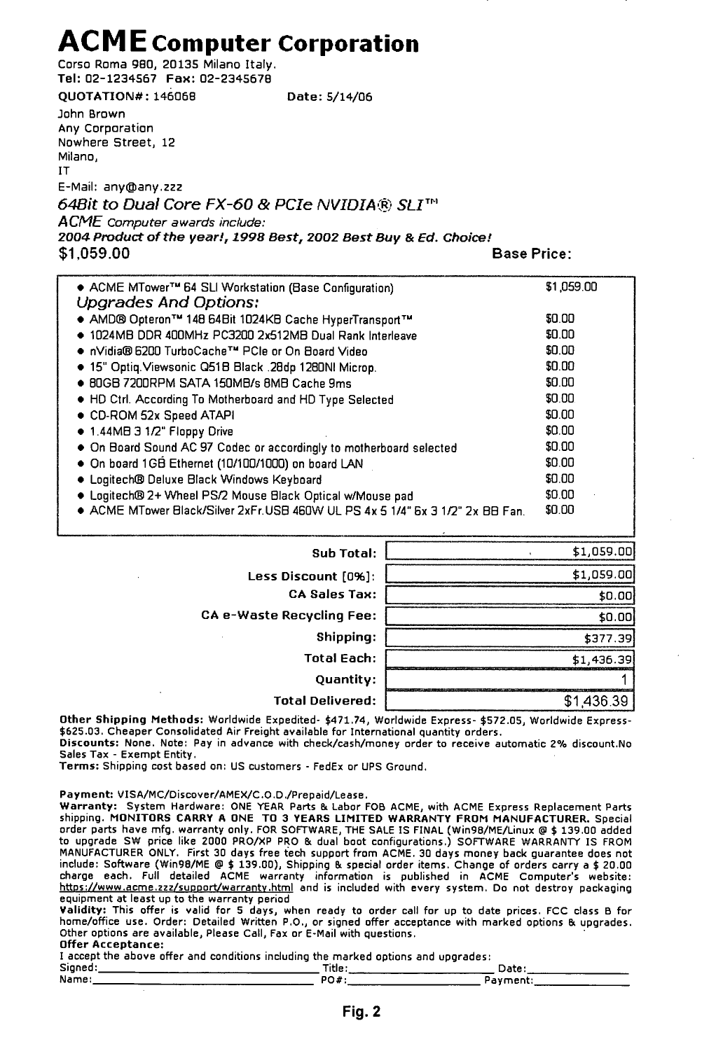

As shown in FIG. 2, the printable quote exactly reflects all the choices of the buyer up to the last moment. Due to the structure of the choice pages, no incompatible choices can be shown here and the order is surely consistent and deliverable within the terms indicated in the quote.

Although the invention has been described in detail for the purpose of illustration only, it is understood that such detail is solely for that purpose and that many variations, changes, additions and substitutions can be made therein by those of ordinary skill in the art without departing from the spirit and scope of the invention, as defined by the following claims, including all equivalents thereof. Even if the examples are related to the sale of computers, all other kinds of complex goods are included in the range of applicability of the invention.

### BRIEF DESCRIPTION OF THE SEVERAL VIEWS OF THE DRAWINGS

FIG. 1 shows an example of an e-commerce web page based on the invention.

FIG. 2 shows an example of a printable quote page based on the invention.

1. An Internet commerce site where the configuration of complex machines can be done on-line even by inexperienced customers.

2. An Internet commerce site according to claim 1 where the final price of complex machines is evaluated in real time with no need for intervention by the company or by the customer.

3. An Internet commerce site according to claim 1 where the configuration of a complex machine can be changed by inexperienced customers without any possibility of wrong or incompatible choices.

4. An Internet commerce site according to claim 2 where a printable quote is automatically generated.

5. An Internet commerce site according to claim 2 where the customer and the salesman can improve the quote in successive steps.
